(19) United States
(12) Patent Application Publication
(10) Pub. No.: US 2009/0208154 A1
(43) Pub. Date: Aug. 20, 2009

(54) PLAIN BEARING BUSH, USE OF THE SAME, AND PRODUCTION THEREOF

(76) Inventors: Klaus Kirchhof, Niedernhausen (DE); Hans-Willi Stiep, Biebelsheim (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/816,873

(22) PCT Filed: Feb. 22, 2006
(86) PCT No.: PCT/EP2006/001582

§ 371 Date: Sep. 9, 2008

(30) Foreign Application Priority Data
Feb. 22, 2005 (DE) 10 2005 009 092.3

(51) Int. Cl. F16C 17/10; F16C 33/20

(52) U.S. Cl. 384/297; 384/276

(57) ABSTRACT

A plain bearing bush includes at least one abutment disk. The plain bearing bush and the abutment disk respectively comprising a steel back and at least one sliding layer. The abutment disk is embodied as a single component or multiple components and is fixed to the front side of the plain bearing bush by means of laser welding.

The invention relates to a plain bearing bush comprising at least one abutment disk according to the preamble of claim 1. The invention also relates to a method for producing such a plain bearing bush.

Rolled plain bearing bushes with collars generally consist of a steel bearing back and a bearing metal or plastic material applied to the inner side as a sliding layer. Such plain bearing bushes are manufactured in one piece, where a cylindrical bush receives a collar in the edge zone by bending. However, limits are imposed on this method. From a certain bushing size and material thickness, the bushes can no longer be formed in the desired manner.

Plain bearing bushes manufactured in one piece have a poor percentage of contact area in the area of the collar as a result of the rounding of the collar and have a V-shaped gap in the area of the joint so that no closed surface is provided.

Known from DE 34 25 180 A1 is a method for producing half bearings with firmly connected thrust flanges in the form of half rings. The half bearings and the thrust flanges are manufactured separately and have a sliding coating on a steel back. On their inner circumference the half rings have a central region with projections, the radius of the inner circumference being equal to the seat of the half bearing. These seats are recessed outer faces at the edge of the half bearing on which the half rings are placed and are then joined to one other also from outside by projection welding or condenser discharge welding. The welding must be carried out rapidly so that no damage is caused to the sliding coatings. A further disadvantage is that the half rings are merely fastened to the half bearings at the projections.

Another method for producing half bearings with axial bearing elements is known from U.S. Pat. No. 4,288,895. The half rings forming the axial bearing elements are welded on to the front side of the half bearing. In order to prevent damage to the sliding layers, both the half bearing and also the half ring are provided with a distinct phase whereby the sliding layer material is removed in the welding region. The half ring also has a significantly larger inner radius than the inner radius of the half bearing. The radial thickness region of the half bearing which is welded to the half ring lies between 0.2 and 0.7 times the thickness of the half bearing to prevent local overheating of the sliding layer. The welding is carried out by means of a laser beam from the inside, where an angle of 30° to 60° to the axis of the half bearing should be observed.

Known from EP 0 306 065 A2 are rolled bushes for plain bearings which are manufactured from a strip section and have a butt joint extending over the entire width of the bearing. In order to restrict the permissible dimensional ranges of the nominal dimensions, the butt joint is closed by charge carrier beam welding.

EP 0 444 755 B1 describes a flanged bearing bush. In this so-called assembled bearing bush, the radial bearing portion comprises deformations in the edge zone which engage in corresponding recesses on the inner circumference of the attached abutment disk in the assembled state. No welding of the bearing bush and the abutment disk takes place.

It is the object of the invention to provide a plain bearing bush with an abutment disk which are permanently joined together, where the manufacture should allow mass production in a simple manner.

The object is achieved with a plain bearing bush in which the abutment disk is embodied as one-part or multi-part and the abutment disk is fixed to the front side of the plain bearing bush by means of laser welding.

The abutment disk can be embodied as one-part or multi-part, preferably as two-part and is preferably stamped from a strip material. The one-part design consists of an abutment ring. The multi-part variant allows stamping-out with minimised waste.

Laser welding is a simple and rapid method for permanently joining the abutment disk and plain bearing bush. In addition, laser welding is gentle on the material because local heating only occurs at the components to be joined. Laser welding is therefore advantageous for plain bearing bushes and abutment disks provided with a heat-sensitive sliding layer material.

The abutment disk is preferably fixed to the front side of the plain bearing bush by means of inner-side laser welding in which the laser beam is directed onto the inner side of the abutment disk and the plain bearing bush.

Since the abutment disk abuts against the front face of the plain bearing bush, the laser welded seam is located on the inner side, i.e. on the inner circumference of the abutment disk and the plain bearing bush or its front face. It has been shown that a more stable fastening can be achieved in contrast to a welded seam on the outer side. In addition, the entire outer circumferential surface of the plain bearing bush is available for grasping and retaining the plain bearing bush because before welding, the plain bearing bush must preferably be pressed into a receiving ring whose dimensions correspond to the final diameter of the bush.

Preferably r≧0.5*d, in particular r>0.7*d and particularly preferably r>0.8*d, where d is the radial thickness of the plain bearing bush and r is the radial extension of the contact surface of the front face of the plain bearing bush. In this case, the value of r is measured from the outer edge of the front face. This means that more than 50% of the front face is used as contact or mounting surface for the abutment disk.

On the other hand, the abutment disk should not cover the entire front face of the plain bearing bush so that the laser beam does impinge upon the sliding layer located on the inner side of the bush and damage this. It is therefore preferable that r<d, in particular r≦(d−dₛ), where dₛ is the thickness of the sliding layer.

The sliding layer of the plain bearing bush preferably extends as far as the front face. If the conditions r≦(d−dₛ) are satisfied, it is not necessary to remove the sliding layer of the plain bearing bush in the area in front of the front face. Preferably r≦0.9*(d−dₛ) is selected. Further preferred values for the lower limit are r≦0.7*(d−dₛ).

The sliding layers of the plain bearing bush and the abutment disk can consist of the same or of different materials. The sliding layers can consist of identical or different metal alloys or of identical or different plastic materials, where a sliding layer made of a metal alloy can also be combined with a sliding layer made of a plastic. The sliding layer materials can be adapted depending on the intended use.

A sintered bronze is preferably provided between the steel layer and the sliding layer. Plain bearing composite materials are used both for the abutment disk and also for the plain bearing bush.

Possible sliding layer materials, for example, are Al—Sn alloys or lead-tin-copper alloys.

Preferably at least one sliding layer consists of a heat-sensitive material. The heat-sensitive materials particularly include plastic materials. Preferred as plastic materials are PTFE with MOS₂, PTFE with PbO, POM or polyetheretherketone.

Preferred uses of these plain bearing bushes with one or two abutment disks are in diesel injection pumps, in automatic gears, in fan motors, in particular in fan motors of lorries or in shock absorbers.

The plain bearing bushes preferably have inside diameters in the range of 15-180 mm, in particular 15-60 mm and 80-180 mm.

According to the method, the object is achieved by the following process steps:
rolling a steel plate comprising at least one sliding layer to form a plain bearing bush,
producing a one-part or multi-part abutment disk from a strip of steel comprising at least one sliding layer,
inserting the plain bearing bush into a clamping device in which the plain bearing bush receives its final diameter,
placing and fixing the abutment disk on the front side of the plain bearing bush,
welding the abutment disk to the plain bearing bush by means of a laser beam and
removing the plain bearing bush from the clamping device.

For welding, the laser beam is preferably directed onto the inner side of the abutment disk and the plain bearing bush. In this case, the laser beam impinges upon the gap region between the abutment disk and the front face of the plain bearing bush. The welding region thus extends in the radial direction.

It has proved to be particularly favourable if the laser beam is aligned at an angle α of 0°-20°, preferably 5°-15° to the perpendicular on the axis of the plain bearing bush. The angle α=0° can be achieved by directing the laser beam by means of an optical device onto the inner side of the abutment disk and plain bearing bush.

Further preferred angular ranges are 5° to 10°, 5° to 15° and 10° to 15°. In this case, the plain bearing bush with the abutment disk is preferably turned under the laser beam.

Exemplary embodiments of the invention are explained hereinafter with reference to the drawings. In the figures:

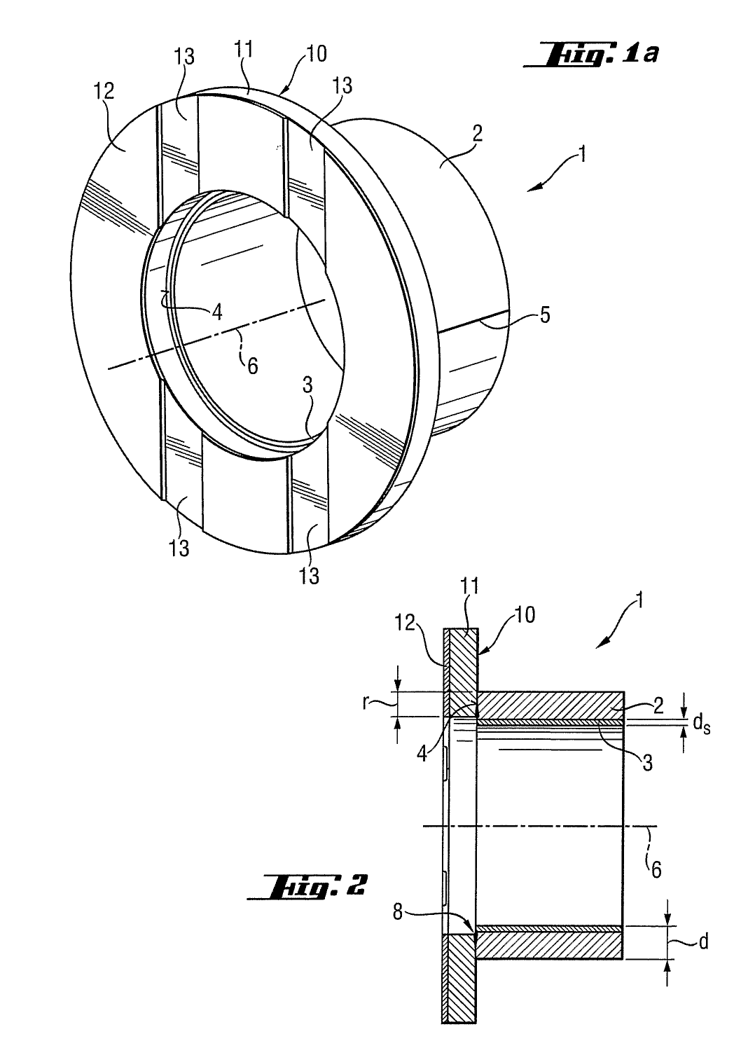

FIGS. 1a, b is a plain bearing bush with an abutment disk according to two embodiments in perspective view,

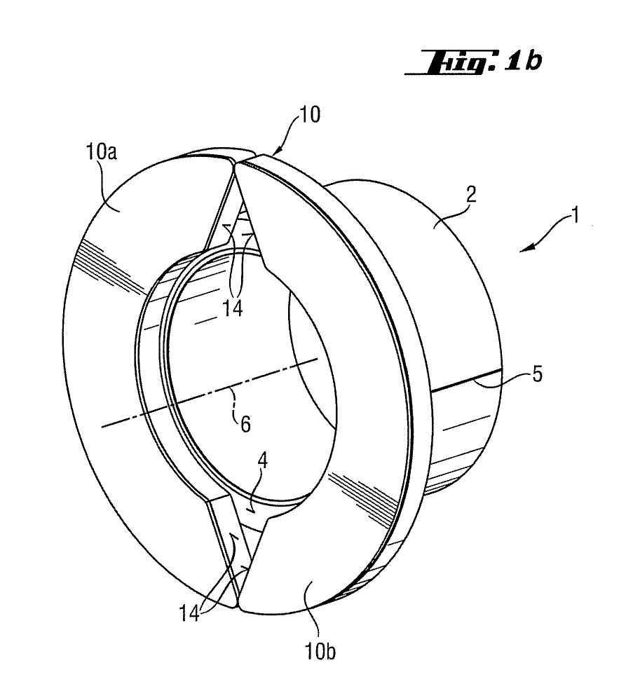

FIG. 2 is a longitudinal section through the plain bearing bush shown in FIG. 1a and

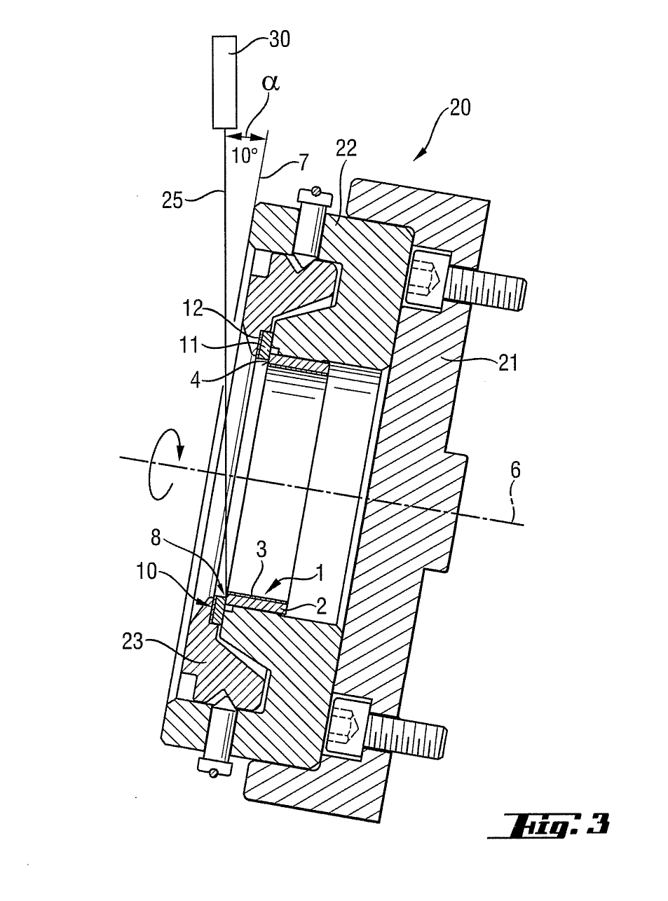

FIG. 3 is a section through the clamping device with the plain bearing bush and abutment disk.

FIG. 1a shows a plain bearing bush 1 with abutment disk 10. This comprises a rolled plain bearing bush with a butt joint 5. The abutment disk 10 which can have a plurality of grooves 13 is welded onto the front face 4.

FIG. 1b shows another embodiment in which the abutment disk 10 is formed from two part rings 10a, b. Each part ring 10a, b has sloping cut-outs 14 at its end which are dependent on the manufacture. It is thus possible to stamp out the part rings 10a, b in close succession adjacent to one another. This minimises waste.

FIG. 2 shows a section through the plain bearing bush 1 shown in FIG. 1. In the view shown here the plain bearing bush 1 consists of a steel back or steel layer 2 having a sliding layer 3 applied to its inner surface. The abutment disk 10 also comprises a steel layer 11 with a sliding layer 12. The sliding layers 3, 12 can consist of metal alloys and/or plastic materials.

The inside diameter of the abutment disk 10 is larger than the inside diameter of the plain bearing bush 1 so that a part of the front face 4 is exposed. The radial extension r of the contact surface from the abutment disk 10 and the plain bearing bush 1 is about 0.75 times d, where d designates the radial thickness of the plain bearing bush 1.

dₛ designates the thickness of the sliding layer 3 of the bush 1. Since r≦(d−dₛ) has been selected in the exemplary representation shown in FIG. 2, the sliding layer 3 of the bush 1 can extend as far as the front face 4 because the laser beam cannot damage the sliding layer 3 when impinging upon the interior joining point 8.

FIG. 3 shows a section through the clamping device 20. After the plain bearing bush 1 has been rolled, it is pressed into the clamping ring 22 which is inserted into a receiving plate 21. The receiving plate 21 is secured on a rotating rotary table (not shown). The pre-fabricated abutment disk 10 is then positioned on the front face 4 and held in the desired position by means of the fixing ring 23.

The entire device is pivoted under the laser beam 25 produced by a laser 30, which impinges on the joining point 8 at an angle α of about 10°. The angle α is relative to the perpendicular 7 on the axis 6 of the plain bearing bush 1.

The laser beam 25 impinges on the inner side of the abutment disk 10 and the plain bearing bush 1. During the welding process the clamping device 20 is rotated under the laser beam 25 so that the entire inner circumference is welded. In this case, the welded seam is formed in the gap between the front face 4 and the abutment disk 10.

After the end of the welding process, the finished plain bearing bush with the welded-on abutment disk 10 is removed from the clamping device.

### REFERENCE LIST

1 Plain bearing bush
2 Steel layer
3 Sliding layer
4 Front face
5 Butt joint
6 Axis of plain bearing bush
7 Perpendicular on axis 6
8 Joining point
10 Abutment disk
10a,b Part ring
11 Steel layer
12 Sliding layer
13 Groove
14 Cut-outs
20 Clamping device
21 Receiving plate
22 Clamping ring
23 Fixing ring
25 Laser beam
30 Laser

1. A plain bearing bush comprising at least one abutment disk, wherein the plain bearing bush and the abutment disk each comprise a steel back and at least one sliding layer, wherein the abutment disk is embodied as one of a one-part or multi-part construction and that the abutment disk is fixed to the front side of the plain bearing bush by means of laser welding.

2. The plain bearing bush according to claim 1, wherein the abutment disk is fixed to the front side of the plain bearing bush by means of inner-side laser welding in which the laser beam is directed onto the inner side of the abutment disk and the plain bearing bush.

3. The plain bearing bush according to claim 1 wherein, r≧0.5*d, where d is the radial thickness of the plain bearing bush and r is the radial extension of the contact surface of the front face of the plain bearing bush.

4. The plain bearing bush according to claim 3, wherein r>0.7*d.

5. The plain bearing bush according to claim 3, wherein r>0.8*d.

6. The plain bearing bush according to claim 3, wherein r<d.

7. The plain bearing bush according to claim 6, wherein r≦(d−dₛ), where dₛ is the thickness of the sliding layer.

8. The plain bearing bush according to claim 1, wherein the sliding layer of the plain bearing bush extends as far as the front face.

9. The plain bearing bush according to claim 1, wherein the sliding layers of the plain bearing bush and the abutment disk consist of the same materials.

10. The plain bearing bush according to claim 1, wherein at least one sliding layer consists of a heat-sensitive material.

11. The plain bearing bush according to claim 1, wherein both sliding layers consist of plastic materials.

12. The plain bearing bush according to claim 1, wherein one sliding layer consists of a plastic material and one sliding layer consists of a metal alloy.

13. The plain bearing bush according to claim 1 mounted in a diesel injection pump.

14. The plain bearing bush according to claim 1 mounted in an automatic gear.

15. The plain bearing bush according to claim 1 mounted in a fan motor of lorries.

16. The plain bearing bush according to claim 1 mounted in a shock absorber.

17-22. (canceled)

23. The plain bearing bush according to claim 1, wherein the sliding layers of the plain bearing bush and the abutment disk consist of different materials.

24. The plain bearing bush according to claim 1, wherein both sliding layers consist of metal alloys.

25. The plain bearing bush according to claim 1, wherein both sliding layers consist of plastic materials and metal alloys.
